(19) United States
(12) Patent Application Publication
(10) Pub. No.: US 2009/0257308 A1
(43) Pub. Date: Oct. 15, 2009

(54) Migration velocity analysis methods

(76) Inventors: Dimitri Bevc, Pleasanton, CA (US); Moritz Matthias Fliedner, San Francisco, CA (US)

Correspondence Address: Dorsey & Whitney LLP;US Bank Center, 1420 Fifth Avenue, Suite 3400, Seattle, WA, 98101-4010, US

(21) Appl. No.: 12/082,474

(22) Filed: Apr. 11, 2008

(51) Int. Cl. G01V 1/28

(52) U.S. Cl. 367/53

(57) ABSTRACT

A method of performing migration velocity analysis may include: obtaining seismic data and an initial velocity model; determining reflection points; deriving a wavepath backprojection operator based on the initial velocity model and the reflection points by constructing wavepaths from each reflection point of the reflection points; and performing a traveltime inversion using the wavepath backprojection operator. The initial velocity model may be updated based on the traveltime inversion. Determining reflection points may be automated by calculating reflection points based on results from a depth migration algorithm performed on the initial velocity model. Selection of residual moveout values may be automated by selecting based on a dip field for each prestack gather obtained from a depth migration algorithm performed on the initial velocity model. Residual traveltimes may be calculated using the selected residual moveout values. The residual traveltimes may be used in the traveltime inversion.

### BACKGROUND

The invention relates generally to migration velocity analysis, and to methods of performing migration velocity analysis that are automated in various respects.

This invention is relevant to seismic data processing in the field of geophysical exploration for petroleum and minerals. The general seismic prospecting method involves the transmission of elastic, or “seismic,” waves into the earth and reception of reflected and/or refracted waves at the earth's surface, or occasionally in a wellbore, via geophones, hydrophones, or other similar devices (“geophones”). The elastic waves are generated by sources such as dynamite, air guns, and hydraulic vibrators. As these waves propagate downward through the earth, portions of their energy are sent back to the earth's surface by the acts of reflection and refraction which occur whenever abrupt changes in impedance are encountered. Since these impedance changes often coincide with sedimentary layer boundaries, it is possible to image the layers by appropriate processing of the signals returned to geophone groups.

While the raw seismic data show existence of formation interfaces, raw data do not accurately inform the interpreter as to the location of these interfaces. The process of migration, also called imaging, is well known in the art, and is the repositioning of seismic data so that a more accurate picture of subsurface reflectors is given. To perform migration calculations, the seismic velocities in the subsurface at a multitude of points must first be determined or approximated.

In the discussions to follow, the unqualified term “velocity” will be used as a short-hand expression that means the velocity of propagation of an acoustic wavefield through earth formations. Generally, for the purposes of this discussion, the term is meant to apply to the propagation of compression waves although shear waves are not excluded. The term “velocity model” is used to refer to the two- or three-dimensional spatial distribution of velocity. The large-scale velocity model covering the extent of the seismic data acquisition volume is usually a complicated structure with vertically and laterally varying velocity.

The commonly used Kirchhoff migration method is well known in the art and requires the calculation of traveltimes through the velocity model. “Traveltime” means generally the amount of time a seismic signal takes to travel from seismic source to a subsurface interface reflection point to a seismic receiver. Current methods of computing traveltimes necessary for two-dimensional and three-dimensional depth migration and associated velocity estimation are inefficient or potentially error-prone when applied to the complicated large-scale velocity models typically encountered.

There are currently two general methods of computing the grid of traveltimes needed to migrate data: the ray tracing methods, and the methods which seek the direct solution of the eikonal equation. As is known to one skilled in the art, the eikonal equation is a form of the wave equation for harmonic waves, valid only where the variation of properties is small within a wavelength, otherwise termed “the high-frequency condition.” The eikonal equation relates the gradient of traveltime to the velocity model.

Seismic ray tracing methods are implemented by solving the ordinary linear differential equations which are derived by applying the method of characteristics to the eikonal equation, a technique known to those skilled in the art. Ray tracing allows the determination of arrival times throughout the subsurface, by following raypaths from a source location according to the known velocity model. Traveltimes along the rays are then interpolated onto a grid of the subsurface. The ray equations may be solved with “shooting” methods or with “bending” methods, both of which are well known to those skilled in the art.

Shooting formulates the ray tracing equations into an initial-value problem, where all ray direction and position components are defined at the source location at time zero. Then equations are recursively solved to trace the rays throughout the medium. Bending formulates the ray tracing equations into a two-point boundary value problem and is based on Fermat's principle, which states that the seismic raypath between two points is that for which the first-order variation of traveltime with respect to all neighboring paths is zero, and attempts to locate a raypath between two points by determining a stationary traveltime path between them. Shooting is generally more efficient computationally than bending; however, both approaches present difficulties and potential inaccuracies when used to compute the gridded traveltime fields required by two- and three-dimensional depth migration. These difficulties and inaccuracies increase with the degree of complexity of the velocity model and with the increase in overall size of the large-scale velocity model. Depth migration typically requires robust grids of traveltimes for high quality images. As used herein, the term “robust” means a process which reliably generates accurate grids of traveltimes regardless of the complexity of the large-scale velocity model.

Because of their efficiency, methods based on direct solutions of the eikonal equation are particularly attractive for the calculation of migration traveltimes. The calculation is performed by finite-differencing the eikonal equation on either a Cartesian grid, or on a polar/spherical grid which is readily interpolated to a Cartesian grid. The traveltimes are piecewise smooth and they fill the computational grid. While methods based on finite-differencing the eikonal equation are efficient and computationally well suited for migration, the solution calculates so called first-arrival traveltimes.

In a large-scale depth model where there are considerable relative changes in velocity, these first-arrival traveltimes often correspond to non-energetic portions of the seismic wavefield. This creates problems for migration since it is critical that the traveltimes used in migration correspond to the energetic portions of the wavefield. Changes in velocity distort the shape of the wave propagation front and create opportunities for frequency components to separate, for headwaves to develop, and for triplications to occur. When high velocity zones are present, the first-arrivals may be non-energetic headwaves. As energy propagates in complicated large-scale models, raypaths tend to eventually cross, which causes phase shifts and triplications. First-arrival traveltimes follow the fastest branch of the triplication bow-tie, which is also the low energy branch. Traveltimes calculated in a large-scale velocity model with a finite-difference method are susceptible to these types of inaccuracies and cannot accurately parameterize the asymptotic Green's functions required for Kirchhoff imaging.

Kirchhoff migration is generally accepted to be a very efficient and practical method of imaging two- and three-dimensional prestack seismic data. However, Kirchhoff algorithms using first-arrival traveltimes typically do a poor job of imaging complex structures, as observed for example by Gray and May, Geophysics 59: 810-817 (1993), and Geoltrain and Brac, Geophysics 58: 564-575 (1993). Even ray tracing methods which calculate multiple arrivals and most energetic arrivals along with estimates of amplitude and phase do not always result in satisfactory images, as indicated by Audebert et. al., (1995) “Imaging Complex Geologic Structure with Single-Arrival Kirchhoff Prestack Depth Migration,” scheduled for publication in Geophysics 62, No. 5 (1997).

Migration methods which use recursive wavefield continuation to backwards propagate the received wavefield, known as wave-equation migration methods, produce excellent images. These migration methods, commonly referred to as “finite-difference migration” or “phase-shift migration” are well known to those skilled in the art.

### SUMMARY

In general, a method of performing migration velocity analysis may be provided. The method may include: obtaining seismic data and an initial velocity model; determining a set of reflection points; deriving a wavepath backprojection operator based on the initial velocity model and the set of reflection points by constructing wavepaths from each reflection point of the set of reflection points; and performing a traveltime inversion using the wavepath backprojection operator. In embodiments, the method may include updating the initial velocity model based on the traveltime inversion. In embodiments, the method may include normalizing the wavepath backprojection operator, wherein the traveltime inversion is performed using the normalized wavepath backprojection operator.

In embodiments, determining a set of reflection points may include calculating reflection points based on results from a depth migration algorithm performed on the initial velocity model. In such embodiments, calculating reflection points may include: calculating a dip field and a coherency of the dip field for each of a plurality of candidate points; and selecting reflection points from the plurality of candidate points based on at least the coherency of the dip field for each candidate point. In such embodiments, selecting reflection points from the plurality of candidate points may also be based on an amplitude value for each candidate point, a spatial density criterion, and/or a semblance value for each candidate point, such as semblance from velocity spectra.

In embodiments, the method may include: selecting residual moveout values based on a dip field for each prestack gather obtained from a depth migration algorithm performed on the initial velocity model; calculating residual traveltimes using the residual moveout values; and performing the traveltime inversion using the residual traveltimes. In such embodiments, selecting residual moveout values may include: calculating a dip field for each prestack image gather; integrating the dip fields to obtain relative depth shifts; and extracting relative depth shifts at each reflection point.

Another method of performing migration velocity analysis may include: obtaining seismic data and an initial velocity model; performing a wave equation depth migration algorithm on the initial velocity model; and determining a set of reflection points by calculating reflection points based on results from the wave equation depth migration algorithm. In such embodiments, the method may further include deriving a backprojection operator based on the initial velocity model and the set of reflection points; and performing a traveltime inversion using the backprojection operator. In such embodiments, the method may further include updating the initial velocity model based on the traveltime inversion.

Another method of performing migration velocity analysis may include: obtaining seismic data and an initial velocity model; selecting residual moveout values based on a dip field for each prestack gather obtained from a migration algorithm performed on the initial velocity model; and calculating residual traveltimes using the residual moveout values. In such embodiments, the method may further include: determining a set of reflection points; deriving a backprojection operator based on the initial velocity model and the set of reflection points; and performing a traveltime inversion using the backprojection operator and the residual traveltimes. In such embodiments, the method may further include updating the initial velocity model based on the traveltime inversion.

### BRIEF DESCRIPTION OF THE DRAWINGS

The patent or application file contains at least one drawing executed in color. Copies of this patent or patent application publication with color drawing(s) will be provided by the Office upon request and payment of necessary fee.

The accompanying drawings, which are incorporated in and form a part of this specification, illustrate various details of the invention and, together with the description, serve to explain the principles of the invention.

FIG. 1 is a flowchart illustrating operations that may be performed for migration velocity analysis according to an embodiment involving wavepath tomography.

FIG. 2 is a flowchart illustrating operations that may be performed for migration velocity analysis according to an embodiment involving automated selection of reflection points.

FIG. 3 is a flowchart illustrating operations that may be performed for migration velocity analysis according to an embodiment involving automated selection of residual moveout values.

FIG. 4 is a flowchart illustrating operations that may be performed for migration velocity analysis according to an embodiment involving wavepath tomography, automated selection of reflection points, and automated selection of residual moveout values.

FIGS. 5a-f are seismic images illustrating selection of reflection points on a two-dimensional Sigsbee synthetic model for subsalt velocity model updating.

FIGS. 6a-b are seismic images illustrating sample wavepaths from the two-dimensional Sigsbee synthetic model.

FIGS. 7a-d are seismic images illustrating upgoing and downgoing wavefields to construct a normal-incidence wavepath for the two-dimensional Sigsbee synthetic model.

FIGS. 8a-d are seismic images illustrating automatic tracing of residual moveout function for selected reflection points.

### DETAILED DESCRIPTION OF EMBODIMENTS

The following description provides examples of methods that may be employed for illustration only, and are not intended to represent the only possible operations. In particular, it should be understood that various methods for carrying out migration velocity analysis or processes involved with such analysis may be envisioned based on the following description. All details appurtenant to implementing the methods that are well understood in the art are omitted for simplicity and clarity.

Generally described, the techniques discussed herein may provide an automated migration velocity analysis that may be characterized as involving wavepath tomography. In particular, the techniques discussed herein may automate selection of reflection points for analysis and/or selection of residual moveout values, from which residual traveltimes may be calculated. Further, the techniques discussed herein may involve wavepath tomography in that a wavepath backprojection operator is derived based on wavepaths from each reflection point. A traveltime inversion may be performed using the wavepath backprojection operator and, for example, using residual traveltimes calculated from the residual moveout values. Thus, it should be understood that the techniques discussed herein may be used in conjunction or separately, as appropriate or desired.

In general, the reflection tomography problem involves three unknown pieces of information in addition to the known acquisition geometry of surface source and receiver locations: (1) the backprojection operator derived from an assumed slowness model; (2) the location and orientation of subsurface reflectors; and (3) a measurement of the deviation of modeled from recorded traveltime. For large seismic surveys, finding all three unknown pieces of information in an automated manner would be helpful, if not necessary.

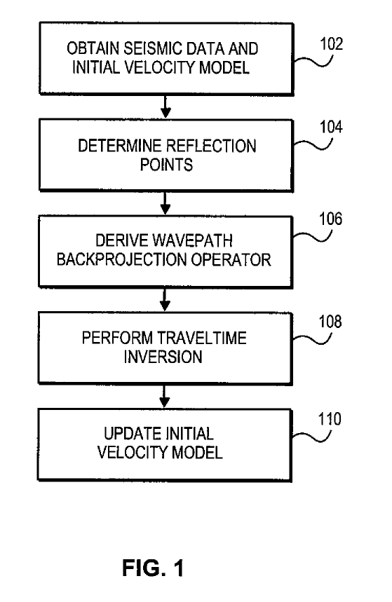

In a particular example, an initial operation 102 may involve obtaining seismic data and an initial velocity model, as illustrated in FIG. 1. The seismic data may be generated by any suitable method, including methods well known in the art. The seismic data may include real data recorded, for example, as discussed above, by any method, whether known or hereafter developed. As used herein, the term “obtaining” should be understood in its most general sense, for example, as in accessing a data storage device including the data, downloading the data from a source, etc. Thus, the initial operation 102 provides the acquisition geometry and the initial velocity or slowness model.

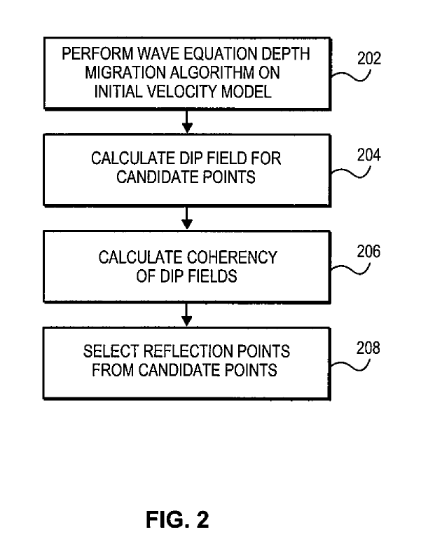

Next, in operation 104, reflection points may be determined. This may be accomplished in an automated way as discussed in more detail below with respect to FIG. 2. Once the reflection points are determined or selected, the wavepath backprojection operator may be derived in operation 106, given the initial velocity model. The wavepath backprojection operator may be derived by known techniques understood as wavepath tomography. For example, derivation of wavepaths in the Born and the Rytov approximations are described in Woodward (Wave-equation tomography: Geophysics, 57, 15-26 (1992)).

Generally, for each reflection point, a wavepath is constructed. Wavepaths may be restricted to the region where the propagated energy is concentrated by muting small contributions from the far field. This may be achieved by setting an amplitude threshold as a percentage of a maximum or average in the wavepath. Alternatively, a mute function may be delineated by the zero crossings of the real part, imaginary part or absolute value of the complex-valued wavepath. Rather than an exhaustive search for zero crossings, a technique of event tracking with a pseudo-eikonal solver as described by Brown et al. (Seismic event tracking by global path optimization: 76^{th} Annual International Meeting, SEG, Expanded Abstracts, 1063-1067 (2006)).

The linearized residual traveltime equation of conventional ray-based tomography is Δτ=LΔs, where Δτ is the residual traveltime, Δs the correction to a reference slowness field, that is, the initial velocity model, discretized into cells, and L is the linearized backprojection operator. In order to use the wavepath backprojection operator with this equation, that is, replace rays with wavepaths, the wavepath backprojection operator is normalized. The L operator is the discretized equivalent of an integration along the raypath with its row sum being the ray length. Replacing rays with wavepaths, the row sum of the operator L becomes a volume. The ratio of ray length to wavepath volume is the normalization factor to be applied to the wavepaths' amplitudes to yield the coefficients of the operator L in the linearized residual traveltime equation. In this context, ray length is defined as a center ray of a wavepath—the trace of the amplitude maximum between surface source and reflection point. For multi-pathing, it may be desirable to subdivide the wavepath into several independent paths or settle on the one most closely aligned with the minimum traveltime path as determined by the eikonal equation.

The wavepath backprojection operator may also be derived from the wavepath amplitudes without any reference to rays by expressing Δτ in terms of the ratio between true and model slowness γ. Beginning with a substitution of the definition of Δs, the linearized residual traveltime equation becomes Δτ=L(s−sₘ), where s is the true slowness and sₘ is the model slowness. Replacing the integration along the raypath approximately with the integration of the average slowness along the raypath, and substituting the definitions of the model traveltime τ and the model slowness γ, yields Δτ=(γ−1)τ. The tomography equation may be rearranged to derive a new wavepath backprojection operator W in terms of average velocity: (γ−1)=(L/τ) Δs=WΔs. The row sum of W is the average velocity. This relationship provides the normalization needed to convert wavepath amplitudes to back projection coefficients.

Once the wavepath backprojection operator is derived, a traveltime inversion may be performed in operation 108, as is well known in the art. Finally, as is also well known in the art, the results of the traveltime inversion may be used to update the initial velocity model in operation 110. It should be understood that the updated velocity model may then be used as the initial velocity model for further updating based on further migration velocity analysis repeating operations 104-110.

As noted above, the reflection points may be determined in an automated manner, as opposed to a manual approach in which reflection points are selected by a geologist interpreting images produced from the velocity model. It should be understood that the automated reflection point selection techniques described herein may be used for ray tracing as well as wavepath tomography approaches to migration velocity analysis.

Once the initial velocity model is obtained, as discussed above with respect to operation 102 of FIG. 1, reflection points may be determined using the initial velocity model. Specifically, a depth migration algorithm, such as those well-known in the art, may be performed on the initial velocity model, as shown in operation 202 of FIG. 2. Any suitable depth migration algorithm that yields prestack gathers, that is, groups of images for each data point, with the sum of prestack images for each data point yielding the stacked image for each data point, may be used. Further, other migration techniques may be employed to obtain prestack gathers, such as Kirchhoff migration, wave-equation migration, reverse time migration (RTM), Tau migration, time migration, etc. Also, other gathers may be obtained, including three-dimensional gathers, angle gathers, ray parameter gathers, offset gathers or time-shift gathers.

Rather than have a geologist interpret the stacked image and draw horizons on the image to manually select reflection points, the techniques described herein involve calculating reflection points from the results of the wave equation depth migration algorithm performed on the initial velocity model. The goal of the calculations is to identify and select only the best data in the prestack image for use as reflection points in velocity model updating.

For example, in operation 204, a dip field or slope may be calculated for candidate points, such as each point of the stacked migrated image. In operation 206, a coherency of each calculated dip field may be calculated. The calculations of the dip field and dip field coherency may be performed by any methods known in the art, such as described in Claerbout (Earth Sounding Analysis: Processing Versus Inversion: Blackwell Scientific Publications (1992)).

Finally, in operation 206, reflection points may be selected from the candidate points. The selection may be performed by applying a “limited picking” algorithm, such as discussed in Clapp (Ray-based tomography with limited picking: Stanford Exploration Project Report No. 110, 103-113 (2001)). The selection may be based on reliability factors extracted from the stack volume, such as amplitude level, dip coherency, and spatial density, that is, a minimum distance between points. The reliability factors provide constraints on selection so that a reasonable number of reflection points may be selected—not too many to be overly computationally demanding, and not too few to be insufficiently representative.

The selection may be performed as an iterative process, with thresholds for the various criteria being progressively relaxed or lowered to find the best points in each region. For example, a first pass may select points that exceed a relatively high threshold, such as the 90 h percentile of amplitude and coherency. Each subsequent pass may lower the threshold to select point to fill in regions without sufficient selected points from previous passes. It should be understood, however, that other search algorithms may be employed, as appropriate or desired, whether recursive or non-recursive.

The ultimate selection of reflection points may involve evaluation of potential reflection points determined as discussed above. For example, potential reflection points may be in regions that should be excluded from velocity model updating, such as salt bodies or a water layer. Such potential reflection points should not be selected. Also, semblance values at the potential reflection points may be another selection criterion. Potential reflection points that have semblance values below a threshold value may be excluded, that is, not selected. Semblance analysis may generate peaks for coherent events that are not primary reflections, such as multiple reflections or other undesirable events, which an automated selector or an unwary human selector may accept as reflection points. As such, potential reflection points that are associated with semblance picks outside a desired range of velocity residuals may be excluded to avoid outliers, such as residual velocities from multiple reflections. Semblance peaks of undesirable events typically correspond to extreme, high or low, residual velocities, thus allowing suspect potential reflection points to be excluded, particularly if the residual velocities deviate abruptly from neighboring ones.

As is well known in the art, some method must be employed to determine the residual traveltimes Δτ to perform the traveltime inversion performed in operation 108 of FIG. 1. For example, residual traveltimes may be calculated from residual moveout values. As noted above, the residual moveout values may be selected in an automated manner, as opposed to a manual approach in which a geologist picks a point for a residual moveout value or depth error for each prestack gather. It should be understood that the automated residual moveout value selection techniques described herein may be used for ray tracing as well as wavepath tomography approaches to migration velocity analysis.

The automated residual moveout value selection techniques described herein differ from the known method of semblance analysis. Semblance analysis generally involves deriving Δτ from a single-parameter hyperbolic curve fit to the observed residual moveout in the common image gathers. For small-scale heterogeneities, semblance analysis may not yield sufficient resolution and a multi-parameter inversion based on the actual residual moveout values from individual image traces may be desirable.

An automated selection of individual residual moveout values is particularly desirable for relatively large prestack images. The techniques described herein may be based on the “flattening” method described in Lomask et al. (Flattening without picking: Geophysics, 71, no. 4, P13-P20 (2006)). Although that flattening method was developed for geological images, that is, stacked images to a geophysicist, the techniques described herein apply such a flattening method to events along the prestack axis to obtain residual moveout values. Specifically, the events to be flattened are reflections in the prestack domain of common image gathers that show residual moveout due to errors in the initial velocity model. It should be understood that other suitable flatting methods or algorithms may be employed, such as differential semblance optimization (DMO).

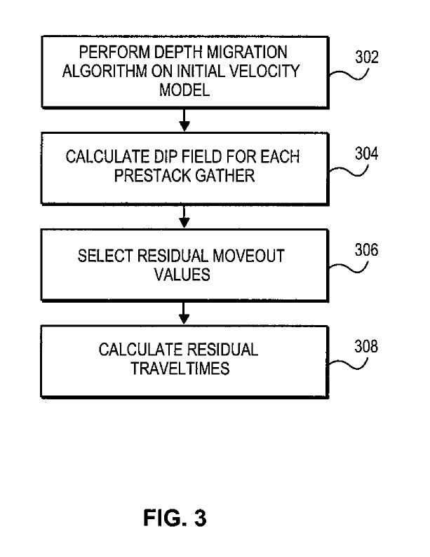

Selection of residual moveout values may be made using the initial velocity model. Specifically, a depth migration algorithm may be performed on the initial velocity model, as shown in operation 302 of FIG. 3. For each of the prestack or common image gathers obtained from the depth migration algorithm, a dip field may be calculated in operation 304.

Residual moveout values may be selected in operation 306 by integrating the dip fields to locate relative depth shifts or residual moveout and extracting the depth shifts at the desired normal incidence locations. For example, the depth shifts may be calculated by a Fourier domain integration as described in Lomask et al., noted above. The extraction may be performed by suitable computer code such that depth shift values/residual moveout values are extracted for each of the reflection points previously determined. For example, individual residual moveout value functions may be extracted by adding the relative depth shift, that is, the difference in depth shift values, between a reference trace, either an incidence trace or a stack trace, and each other trace at the event depth in the reference trace, that is, the location of the selected reflection point.

Finally, in operation 308, the residual traveltimes Δτ may be calculated from the depth shift/residual moveout values using a known relationship, for example: Δτ=2*s*Δz*cos(Φ)*cos(θ), where s is the local slowness above the reflector at the reflection point, Φ is the angle of the reflector slope from horizontal, and θ is the angle of incidence of the ray or wavepath, as set forth in Stork (Reflection tomography in the postmigrated domain: Society of Exploration Geophysics, 57, 680-692 (1992)). Other suitable equations, such as Δτ=(γ−1)τ₀, as follows from the derivation in Ji (Tomographic velocity estimation with plane-wave synthesis: Geophysics, 62, 1825-1838 (1997)), or variants of such equations may be used. As discussed above, once calculated, the residual traveltimes Δτ may be used to perform the traveltime inversion for updating the initial velocity model.

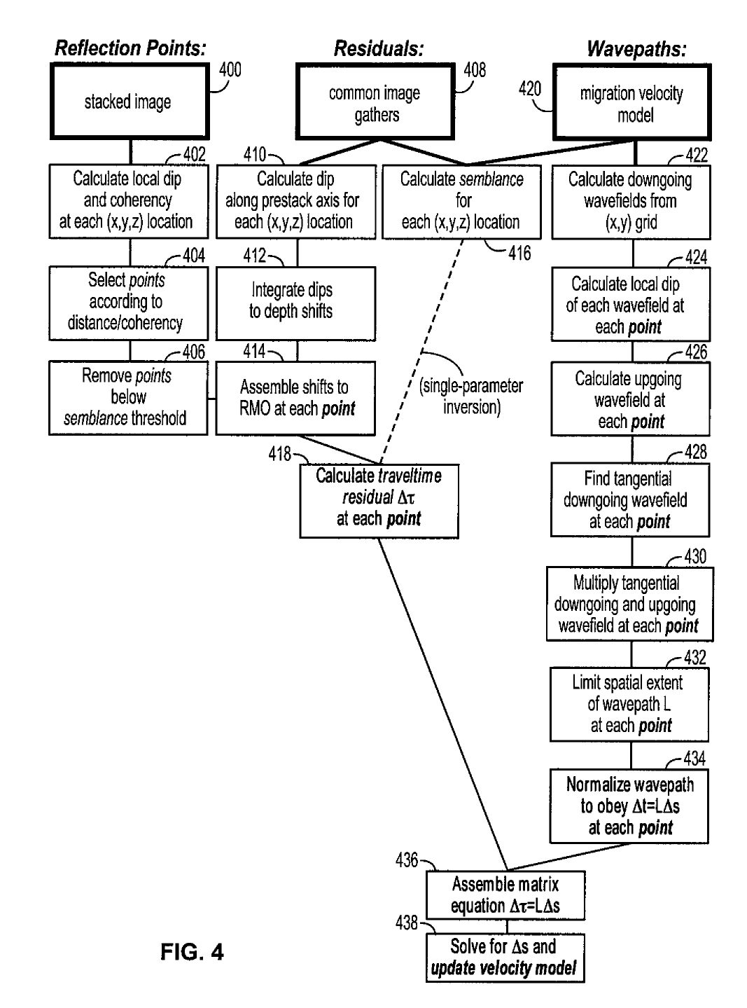

As discussed above, the techniques described herein may be used in conjunction to perform migration velocity analysis and updating of the initial velocity model. FIG. 4 provides a flowchart illustrating the possible interrelation between the techniques of determining reflection points, selecting residual moveout values and calculating residual traveltimes, and constructing wavepaths to derive the wavepath backprojection operator in an overall process of migration velocity analysis and velocity model updating. It should be understood the operations in FIG. 4 may be performed concurrently or in a different order than described, as appropriate or desired, and that the flowchart of FIG. 4 is intended only to provide an overview of an example of migration velocity analysis for velocity model updating.

The operations under the heading “Reflection Points:” may be performed starting with operation 400 in which the stacked image is obtained using the initial velocity model. Next, in operation 402, the dip field and dip coherency at each candidate point is calculated. Then, in operations 404 and 406, reflection points may be selected, for example, according to distance and/or coherency, and removed or excluded based on semblance values.

The operations under the heading “Residuals:” may be performed starting with operation 408 in which the prestack or common image gathers are obtained using the initial velocity model. Next, in operation 410, the dip field for each prestack gather is calculated. Then, in operations 412 and 414, the dip fields are integrated to obtain depth shifts and the depth shifts are extracted for each reflection point selected from the operation performed under the heading “Reflection Points:”. Alternatively, semblance analysis may be performed in operation 416. In either case, the residual traveltimes are calculated in operation 418 based on the results of either operation 414 or operation 416.

The operations under the heading “Wavepaths:” may be performed starting with operation 420 in which the initial velocity model is obtained. Using the initial velocity model, operations 422-430 may be performed to derive the wavepath backprojection operator for each of the selected reflection points. In particular, wavepaths may be constructed by calculating the wavefields, that is, impulse responses of the migration operator at a chose seismic frequency, for a grid of surface locations to obtain downgoing wavefields, in operation 422, and for all the selected backprojection or reflection points to obtain upgoing wavefields, in operation 426. For each upgoing wavefield, the downgoing wavefield that illuminates the respective reflection point at normal incidence may be determined, for example, by calculating the local dip field of the downgoing wavefield at the reflection point, in operation 424, and matching that with the reflector dip, in operation 428. The wavepath or wavepath kernel may be generated in operation 430 by multiplying the corresponding upgoing and downgoing wavefields. As appropriate or desired, the spatial extent of the wavepath may then be restricted in operation 432 by muting low-amplitudes far from a center of the wavepath, for example, as discussed above. Finally, in operation 434, the amplitude values of the wavepath may be normalized to fulfill the traveltime inversion equation, that is, the wavepath backprojection operator may be normalized so that it may be used in the traveltime inversion equation.

The traveltime inversion equation may be assembled, in operation 436, using the wavepath backprojection operator derived in operations 422-434 and the residual traveltimes calculated in operation 418. Finally, in operation 438, a traveltime inversion may be performed to solve for the velocity error Δs, which may be used to update the initial velocity model.

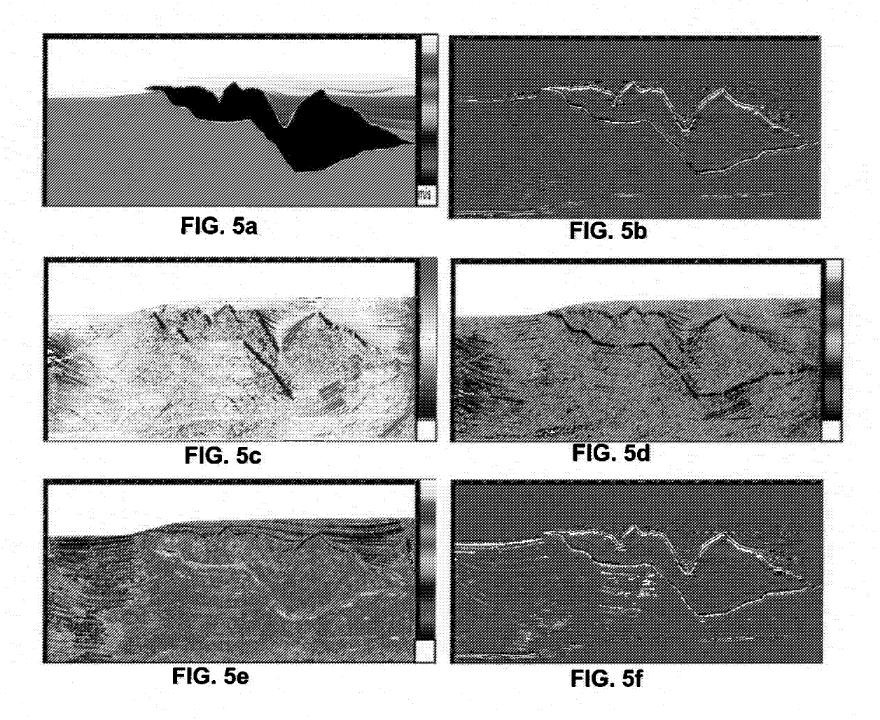

Seismic images produced by performing various techniques described herein are illustrated in FIGS. 5a through 8d. As a person skilled in the art would understand how to interpret such images, only a general description of the images is provided in terms of the corresponding operations of the techniques described herein.

As noted above, FIGS. 5a-f are seismic images illustrating selection of reflection points on a two-dimensional Sigsbee synthetic model for subsalt velocity model updating. In particular, FIG. 5a illustrates an initial velocity model for migration of the Sigsbee synthetic seismic data. Note that the model is correct except for the constant velocity layer inserted below the salt body. FIG. 5b illustrates a seismic image stack obtained by wave-equation migration of the Sigsbee synthetic seismic data with the velocity model shown in FIG. 5a. FIG. 5c illustrates the dip field calculated from the image shown in FIG. 5b. FIG. 5d illustrates the coherency of the dip field shown in FIG. 5c. FIG. 5e illustrates maximum semblance strength of velocity spectra calculated from the migrated image gathers. FIG. 5f illustrates automatically selected backprojection points superimposed on the image of FIG. 5b, with the color corresponding to residual velocity determined from maximum semblance of velocity spectra, and the dip bar indicating local orientation of reflectors as given by the dip field of FIG. 5c. Selection is based on image amplitude, dip coherency, semblance strength and minimum distance criteria.

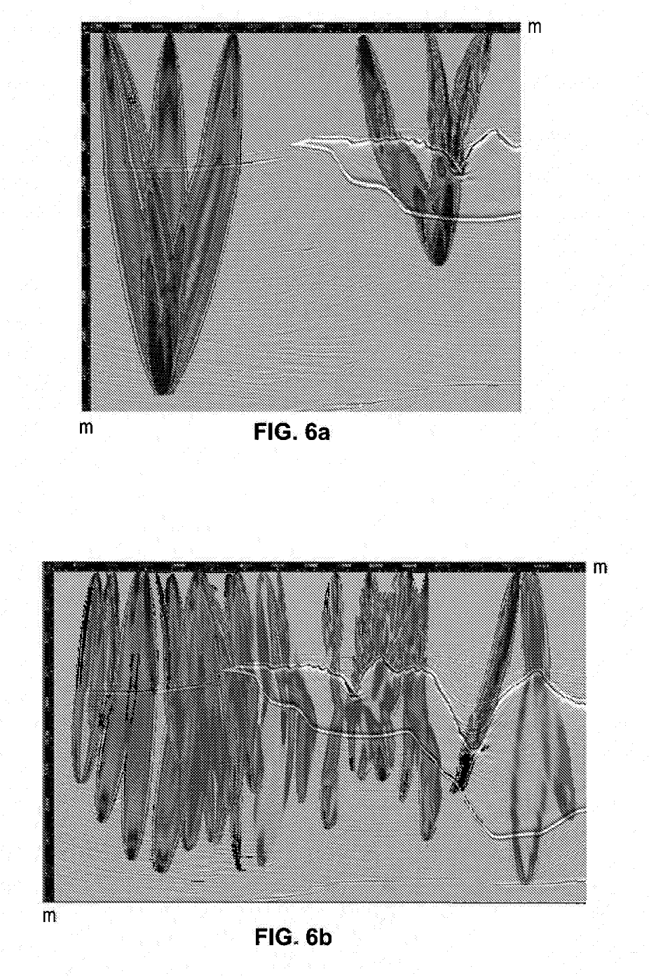

FIGS. 6a-b are seismic images illustrating sample wavepaths from the two-dimensional Sigsbee synthetic model. FIG. 6a illustrates wavepath “fans” from two backprojection points, at normal incidence where source and receiver coincide at the surface and at oblique incidence where source and receiver are offset at the surface. FIG. 6b illustrates normal-incidence wavepaths from several backprojection points in the deep sedimentary and subsalt sections of the Sigbee model. Colors show the relative energy in the wavepath, from small in light color to large in dark color, and therefore show relative size of the inversion matrix coefficient or local Frechet derivative.

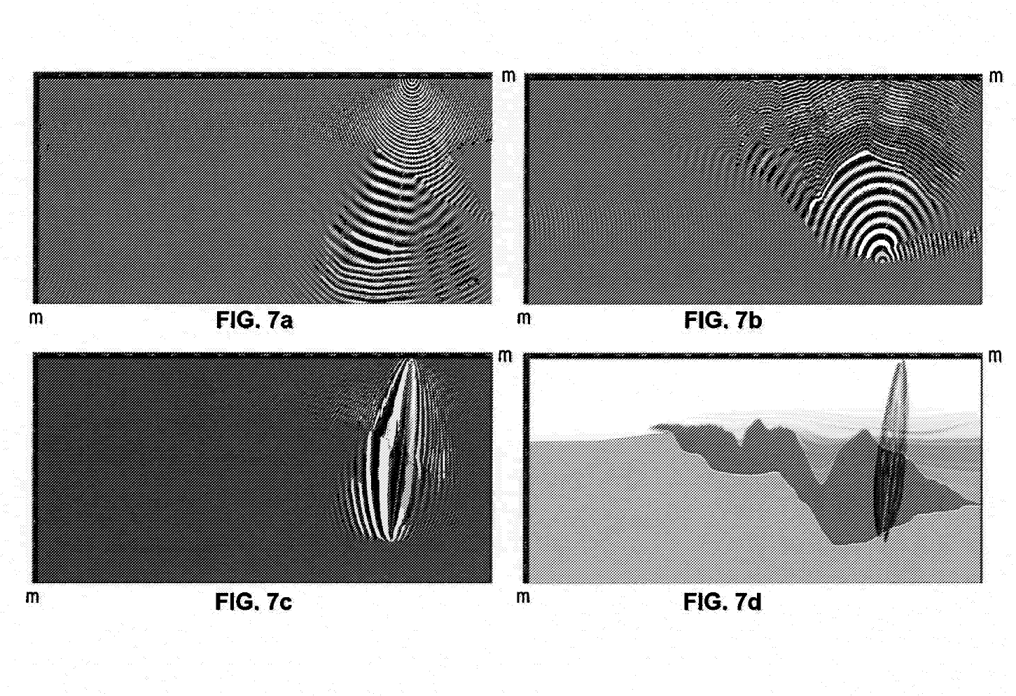

FIGS. 7a-d are seismic images illustrating upgoing and downgoing wavefields to construct a normal-incidence wavepath for a subsalt reflection point in the two-dimensional Sigsbee synthetic model. FIG. 7a illustrates a wavefield propagating downward from the surface source/receiver location, that is, the downgoing wavefield or impulse response of the wave-equation migration operator with a source at the source/receiver surface location. FIG. 7b illustrates a wavefield propagating upward from the reflection point, that is, the upgoing wavefield or impulse response of the wave-equation migration operator with a source at the reflection point. FIG. 7c illustrates the product of the wavefields shown in FIGS. 7a and 7b. FIG. 7d illustrates a muted wavepath superimposed on the velocity model shown in FIG. 5a. The orange line shows the normal incidence ray path traced from the reflection point to the surface through the velocity model shown in FIG. 5a.

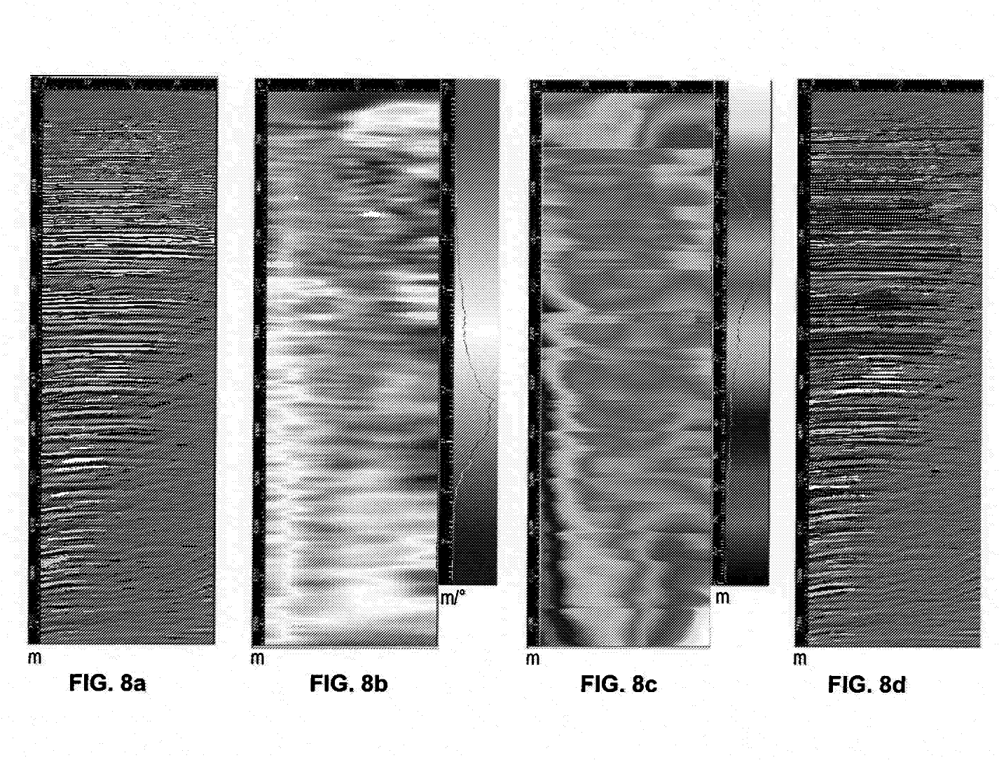

FIGS. 8a-d are seismic images illustrating automatic tracing of residual moveout function for selected reflection points. FIG. 8a illustrates a wave-equation-migrated seismic image gather, that is, an angle domain common image gather (ADCIG) for a single surface location of a seismic survey, wherein the vertical axis is depth and the horizontal axis is reflection angle. FIG. 8b illustrates the dip field calculated from the ADCIG shown in FIG. 8a. FIG. 8c illustrates relative depth shifts calculated from the dip field shown in FIG. 8b. FIG. 8d illustrates blue residual moveout curves, in blue, extracted from the relative depth shifts shown in FIG. 8c at given reflection points on the normal incidence or zero degree reflection angle trace.

Although various details have been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention.

What is claimed is:

1. A method of performing migration velocity analysis, the method comprising:
obtaining seismic data and an initial velocity model;
determining a set of reflection points;
deriving a wavepath backprojection operator based on the initial velocity model and the set of reflection points by constructing wavepaths from each reflection point of the set of reflection points; and
performing a traveltime inversion using the wavepath backprojection operator.

2. The method of claim 1, further comprising updating the initial velocity model based on the traveltime inversion.

3. The method of claim 1, further comprising normalizing the wavepath backprojection operator, wherein the traveltime inversion is performed using the normalized wavepath backprojection operator.

4. The method of claim 3, further comprising updating the initial velocity model based on the traveltime inversion.

5. The method of claim 1, wherein determining a set of reflection points includes calculating reflection points based on results from a depth migration algorithm performed on the initial velocity model.

6. The method of claim 5, wherein calculating reflection points includes:
calculating a dip field and a coherency of the dip field for each of a plurality of candidate points; and
selecting reflection points from the plurality of candidate points based on at least the coherency of the dip field for each candidate point.

7. The method of claim 6, wherein selecting reflection points from the plurality of candidate points is also based on an amplitude value for each candidate point.

8. The method of claim 6, wherein selecting reflection points from the plurality of candidate points is also based on a spatial density criterion.

9. The method of claim 6, wherein selecting reflection points from the plurality of candidate points is also based on semblance values for candidate points.

10. The method of claim 9, wherein the semblance values are derived from velocity spectra.

11. The method of claim 1, further comprising:
selecting residual moveout values based on a dip field for each prestack gather obtained from a depth migration algorithm performed on the initial velocity model;
calculating residual traveltimes using the residual moveout values; and
performing the traveltime inversion using the residual traveltimes.

12. The method of claim 11, further comprising updating the initial velocity model based on the traveltime inversion.

13. The method of claim 11, wherein selecting residual moveout values includes:
calculating a dip field for each prestack image gather;
integrating the dip fields to obtain relative depth shifts; and
extracting relative depth shifts at each reflection point.

14. A method of performing migration velocity analysis, the method comprising:
obtaining seismic data and an initial velocity model;
performing a wave equation depth migration algorithm on the initial velocity model; and
determining a set of reflection points by calculating reflection points based on results from the wave equation depth migration algorithm.

15. The method of claim 14, further comprising:
deriving a backprojection operator based on the initial velocity model and the set of reflection points; and
performing a traveltime inversion using the backprojection operator.

16. The method of claim 15, further comprising updating the initial velocity model based on the traveltime inversion.

17. A method of performing migration velocity analysis, the method comprising:
obtaining seismic data and an initial velocity model;
selecting residual moveout values based on a dip field for each prestack gather obtained from a migration algorithm performed on the initial velocity model; and
calculating residual traveltimes using the residual moveout values.

18. The method of claim 17, further comprising:
determining a set of reflection points;
deriving a backprojection operator based on the initial velocity model and the set of reflection points; and
performing a traveltime inversion using the backprojection operator and the residual traveltimes.

19. The method of claim 18, further comprising updating the initial velocity model based on the traveltime inversion.
